(19) United States
(12) Patent Application Publication
(10) Pub. No.: US 2006/0126772 A1
(43) Pub. Date: Jun. 15, 2006

(54) Container inspection system with CT tomographic scanning function

(75) Inventors: Haifeng Hu, Beijing (CN); Qitian Miao, Beijing (CN); Liming Wang, Beijing (CN); Kejun Kang, Beijing (CN); Zhiqiang Chen, Beijing (CN); Yucheng Wu, Beijing (CN); Shangmin Sun, Beijing (CN); Yanjun Han, Beijing (CN); Hua Peng, Beijing (CN); Nan Jiang, Beijing (CN); Zhizhong Liang, Beijing (CN)

Correspondence Address: KINNEY & LANGE, P.A., THE KINNEY & LANGE BUILDING, 312 SOUTH THIRD STREET, MINNEAPOLIS, MN, 55415-1002, US

(73) Assignees: Nuctech Company Limited, Beijing (CN); Tsinghua University, Beijing (CN)

(21) Appl. No.: 11/287,332

(22) Filed: Nov. 23, 2005

(30) Foreign Application Priority Data
Nov. 26, 2004 (CN) 200410009890.9

(51) Int. Cl. G21G 1/00

(52) U.S. Cl. 376/156

(57) ABSTRACT

A container inspection system with CT tomographic scanning function, which is related to a large container inspection system for Customs, is disclosed, comprising: a radiation source; an annular rotatable rack with the radiation source provided at the outside thereof and rotated with it; an annular rack body for supporting the annular rotatable rack in a vertical plane; a driving device for rotating the annular rotatable rack; a detector array provided in the inner side of said annular rotatable rack and opposed to a side where the radiation source is provided; a transmission device passing through the annular rotatable rack and annular rack body, and transmitting a container truck to be detected in linear movement; a remote control device for controlling the operations of the radiation source, the driving device and the transmission device, and receiving/displaying the image signal obtained by the detector array. Not only can general inspection of the objects to be detected be undertaken, but also does repeated tomographic inspection of suspicious locations within the inspected objects, thus achieves effective accuracy improvement of the contrabands detection.

### TECHNICAL FIELD

The present invention relates to a large container inspection system for Customs, especially to a container inspection system with CT tomographic scanning function.

### TECHNOLOGY BACKGROUND

Conventionally, a pulling container inspection system emerged at the beginning of 90s', such as the large container inspection systems manufactured by Haiman Corporation, Germany and British Airspace Corporation. The above inspection systems are devised as follows. A radiation source which is stationary and produces high energy x-rays and detector array which receive x-rays passing through the container are mounted in an inspection passage which is capable of shielding radiation beams. A vehicle carrying the container is pulled by a special pulling device so as to pass by the inspection passage. When the container passes x-ray, x-ray will transmit through the container and incident on the detectors. As a result, the density distribution of the objects contained in the container is presented according to the variation of the intensity of the x-rays. Then, the intensity of the x-rays is converted into a corresponding gray degree of an image so that a perspective view of the objects contained in the container can be obtained. A self-scanning radiation inspection system for large scale objects is disclosed in Chinese Patent ZL 95103044.2, comprising a radiation source, a collimating tower, tracks and a scanning gantry. The radiation source provided on the track reciprocates thereof, the collimating tower and detecting tower are provided on another track, moving synchronously together with the radiation source by a servo-motor. The large scale object to be inspected is provided between the tracks of the collimating and detecting towers, with beams from the radiation source passing through the collimating tower and then entering into the detector array of the detecting tower after penetrating through the container, the detectors receiving the beams and outputting charges which are transmitted to the image station after digital conversion, thus obtaining the scenographic image of the objects in the container.

The above-mentioned X-ray radiation imaging inspection system usually moves only in one direction with respect to the objects to be inspected due to the fixed configuration of the detecting device, therefore, only scenographic image can be obtained, rather than the tomographic image of a part in the object to be inspected, which limites the inspection accuracy for complex container cargo on a certain degree.

### SUMMARY OF THE INVENTION

Accordingly, the present invention has been made to overcome the above mentioned problems, it is an object of the invention to provide a container inspection system with CT tomographic scanning function, which can detect the objects multi-dimensionally and multi-view, thus improving the detection accuracy.

It is an aspect of the invention to provide a container inspection system with CT tomographic scanning function, which can undertake not only general inspection of detected objects, but also repeatedly inspects suspicious locations of the inspected objects tomographically, and thus achieves effective accuracy improvement of the contrabands detection.

The foregoing and/or other aspects of the present invention can be achieved by providing a container inspection system with CT tomographic scanning function, comprising: a radiation source for emitting scanning radiation beam; an annular rotatable rack with the radiation source provided at the outside thereof and rotated with it; an annular rack body for supporting said annular rotatable rack in a vertical plane; a driving device for rotating said annular rotatable rack; a detector array provided in the inner side of said annular rotatable rack and opposed to a side where the radiation source is provided; a transmission device passing through said annular rotatable rack and annular rack body, and transmitting a container truck to be detected in linear movement; a remote control device for controlling the operations of said radiation source, said driving device and said transmission device, and receiving/displaying the image signal obtained by said detector array.

In the above mentioned inspection system, said transmission device comprises a first transmission device and a second transmission device, which form intermittent gaps at place where the first and second transmission devices traverse said annular rotatable rack.

In the above mentioned inspection system, a traction device is provided upon said first transmission device to move said container truck linearly.

In the above mentioned inspection system, said first and second transmission devices are guide devices which can move synchronously and reciprocatingly.

In the above mentioned inspection system, said guide devices are of a sheet type transporting chain structure carried by multiple rows of cylindrical roller.

In the above mentioned inspection system, a corrector opposed to said radiation source is further fixed on the outer side of said annular rotatable rack, a front collimator is fixed at the inner side of the annular rotatable rack 4, the outside of which is exactly confronted with the corrector 2, and a rear collimator is provided in front of said detector array.

In the above mentioned inspection system, said driving device comprises a motor, a decelerator driven by said motor, a spur gear driven by said decelerator, and an outer annular gear engaged with the spur gear, wherein the outer annular gear is fixed tightly on the outer wall of the annular rotatable rack.

In the above mentioned inspection system, said driving device comprises a motor, a decelerator driven by said motor, a friction roller driven by said decelerator, and a friction ring engaged with the friction roller, wherein the friction ring is fixed tightly on the outer wall of the annular rotatable rack.

In the above mentioned inspection system, said radiation source is a linear electron accelerator or an isotope.

The general inspection can be undertaken when the transmission device transports the container truck passing through the annular rotatable rack, since the radiation source, the front collimator, the rear collimator and detector array are all fixed within the annular rotatable rack that can rotate. When suspicious articles are found in the object to be inspected, the transmission device is back off with the suspicious parts receded to a position within the annular rotating rack, which is just the gap of the transmission device, thus there is no any obstruction to the articles being detected during scanning. Then, the annular rotatable rack is activated to undertake CT tomographic scanning of the suspicious parts, and the results of the inspection is much more accurate. The present invention has the advantages of sound design, easiness of manipulation, convenient maintenance and still less area coverage, etc. compared to conventional art. Therefore, it is an indispensable device for Customs inspecting large-sized container.

### BRIEF DESCRIPTION OF THE DRAWINGS

The above and/or other aspects and advantages of the present invention will become apparent and more readily appreciated from the following description of the exemplary embodiments, taken in conjunction with the accompany drawings, in which:

FIG. 1 is a schematic view of structural installation of the present invention;

FIG. 2 is a sectional view along A-A direction of FIG. 1 according to an embodiment of the present invention; and

FIG. 3 is a sectional view along A-A direction of FIG. 1 according to another embodiment of the present invention.

### DETAILED DESCRIPTION OF THE PREFERRED EMBODIMENT

Reference will no be made in detail to the embodiments of the present invention, examples of which are illustrated in the accompany drawings, wherein like reference numerals refer to like elements throughout. The embodiments are described below so as to explain the present invention by referring to the figures.

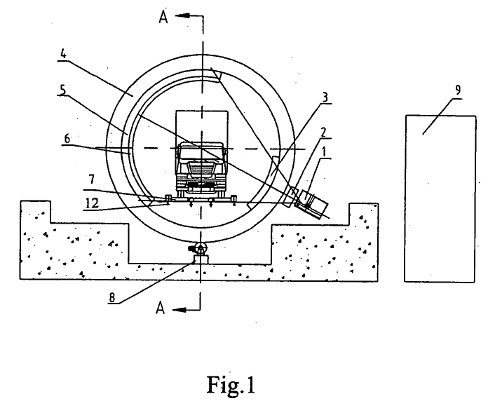

As shown in FIG. 1-3, a container inspection system with CT tomographic scanning function according to the present invention is composed of a radiation source 1 for emitting X-ray radiation beam, a annular rotating rack 4 with the radiation source 1 provided at the outside thereof and rotated with it, an annular rack body 10 supporting the annular rotatable rack 4 in a vertical plane, general bearing supporting structure 16 is preferably used, a driving device 8 for driving the annular rotatable rack 4 to rotate; a detector array 5 provided in the inner side of the annular rotatable rack 4 and opposed to a side where the radiation source 1 is provided; a transmission device 12 passing through the annular rotatable rack 4 and annular rack body 10, and transmitting a container truck to be detected in linear movement; a remote control device 9 for controlling the operation of the radiation source 1, the driving device 8 and the transmission device, the remote control device 9 is often provided with a image acquisition module, a operation detecting module, and an electrical controlling module etc., and receives the image signal obtained by the detector array 5, displaying in image accordingly after the processing of the obtained signal. Since the image acquisition module, operation detecting module, the mutual conversion between the image signals of the detector array and electrical signals of the electrical controlling module, and image display are prior art, repeated description are omitted for brevity.

In the above-mentioned container inspection system, preferably, as shown in FIG. 1, a corrector 2 opposed to the radiation source is further fixed on the outer face of the annular rotatable rack 4, a front collimator 3 is fixed at the inner side of the annular rotatable rack 4, the outside of which is exactly confronted with the corrector 2, and a rear collimator 6 is provided in front of the detector array 5. Therefore, the whole scanning system composed of the radiation source 1, the corrector 2, the front collimator 3, the rear collimator 6 and the detector array 5 is provided upon the annular rotatable rack 4 and rotate together with the annular rotatable rack 4 around the object to be inspected, achieving the CT tomographic scanning of the object to be inspected accordingly. The corrector 2, front collimator 3, rear collimator 6 and detector array 5 are sequentially provide upon the annular rotatable rack 4, the sizes of which are arranged so as to be conformed to the sector shape formed by the X ray radiated from the radiation source 1. Thus, the sectorial X ray emitted from the radiation source 1 is exactly directed to the rear collimator 6 and detector array 5 after passing the front collimator 3 and container truck, the scanning signal obtained by the detector 5 is transmitted to the remote control device 9 for processing and displaying. The radiation source, preferably, is a linear electric accelerator or an isotope.

The driving device 8 comprises a motor 18, a decelerator driven by said motor 18, a spur gear (or a friction roller) driven by said decelerator, and an outer annular gear (or a friction roller) engaged with the spur gear (or the friction roller), wherein the outer annular gear (or friction roller) is fixed tightly on the outer wall of the annular rotatable rack. Therefore, the motor 18 outputs power through the decelerator, the spur gear driving the outer annular gear is connected to the output shaft of the decelerator, thus rotating the annular rotatable rack 4. The motor 18, preferably, is a reversible servo-motor, to drive the outer annular gear in a predetermined range of revolving angle. The annular rotatable rack 4 is supported by the annular rack body 10 fixed on the ground and is revolved in a vertical plane around a fixed center by the driving device 8.

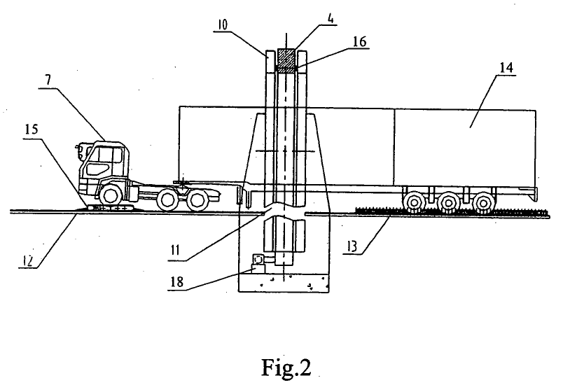

In the above mentioned inspection system, the transmission device 12 comprises a first and second transmission device, which form intermittent gaps 11 at a position where the first and second transmission devices traverse the annular rotatable rack 4. The annular rotatable rack 4 is provided in the longitudinal direction of the intermittent gaps 11 to allow the container truck to be inspected to pass therethrough for preventing radiation rays produced by the radiation source from being obstructed during tomographic scanning. In an embodiment of the invention, as shown in FIG. 2, the first transmission device is provided with a traction device 15, so that a truck 7 for drawing the container can be pre-piloted onto the traction device 15, then the driver leaves the cab in case of X-ray radiation to the driver during container inspection, the traction device 15 draws the container truck 14 to be inspected in linear movement on the first and second transmission device, for general scanning and CT tomographic scanning inspection. In this embodiment, the first and second transmission device may be any ones which are used to support the container truck 14 to be inspected to move thereon, for example, guide rails, even fixed ground and the like.

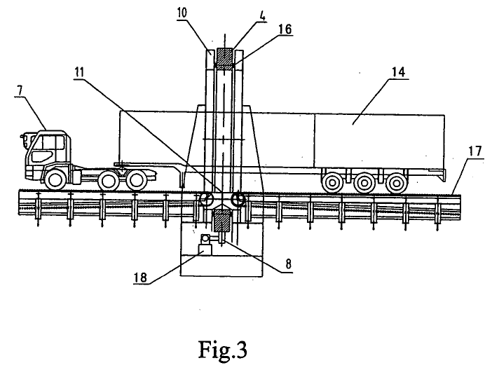

In another embodiment of the present invention, as shown in FIG. 3, the first and second transmission devices are guide devices 17 that can move synchronously, and form intermittent gaps 11 at a position where the first and second transmission devices traverse the annular rotatable rack 4. The annular rotatable rack 4 is provided in the longitudinal direction of the intermittent gaps 11 to allow the container truck to be inspected to pass therethrough. The guide devices 17 can move reciprocally. Thus, general scanning inspection can be undertaken by the transmission device carrying the container truck through the annular rotatable rack 4 under the control of the remote control device 9. When suspicious articles are found in the object to be inspected, the transmission device is controlled to be back off until the suspicious parts within the container truck to be inspected are receded within the annular rotating rack 4, the annular rotatable rack 4 is driven to reversely rotate and undertakes CT tomographic scanning for the suspicious parts. After inspection, the transmission device carries the container truck to the exit of the scanning passage, of which the truck is driven out, waiting for inspection results, meanwhile the next inspection of a container truck can be undertaken continuously. In the embodiments of the present invention, the guide devices 17 preferably is of a sheet type transporting chain structure carried by multiple rows of cylindrical roller, and are preferably driven in a manner of general rail elevator.

Although preferred embodiments have been described, it would be appreciated by those skilled in the art that the present invention may be made in any other mode without departing from the principles and spirit of the invention.

1. A container inspection system with CT tomographic scanning function, comprising:
a radiation source for emitting a scanning radiation beam;
an annular rotatable rack with the radiation source provided at an outside thereof and rotated with it;
an annular rack body for supporting said annular rotatable rack in a vertical plane;
a driving device for rotating said annular rotatable rack;
a detector array provided in an inner side of said annular rotatable rack and opposed to a side where the radiation source is provided;
a transmission device passing through said annular rotatable rack and annular rack body, and transmitting a container truck to be detected in linear movement; and
a remote control device for controlling the operations of said radiation source, said driving device and said transmission device, and receiving/displaying the image signal obtained by said detector array.

2. A container inspection system according to claim 1, wherein, said transmission device comprises a first transmission device and a second transmission device, which form intermittent gaps at place where the first and second transmission devices traverse said annular rotatable rack.

3. A container inspection system according to claim 2, wherein, a traction device is provided upon said first transmission device to move said container truck linearly.

4. A container inspection system according to claim 2, wherein, said first and second transmission devices are guide devices s which can move synchronously and reciprocatingly.

5. A container inspection system according to claim 4, wherein, said guide devices s is of a sheet type transporting chain structure carried by multiple rows of cylindrical roller.

6. A container inspection system according to claim 1, wherein, a corrector opposed to said radiation source is further fixed on the outer face of said annular rotatable rack, a front collimator is fixed at the inner side of the annular rotatable rack, the outside of which is exactly confronted with the corrector, and a rear collimator is provided in front of said detector array.

7. A container inspection system according to claim 1, wherein, said driving device comprises a motor, a decelerator driven by said motor, a spur gear driven by said decelerator, and an outer annular gear engaged with the spur gear, wherein the outer annular gear is fixed tightly on the outer wall of the annular rotatable rack.

8. A container inspection system according to claim 1, wherein, said driving device comprises a motor, a decelerator driven by said motor, a friction roller driven by said decelerator, and a friction ring engaged with the friction roller, wherein the friction ring is fixed tightly on the outer wall of the annular rotatable rack.

9. A container inspection system according to claim 1, wherein, said radiation source is a linear electron accelerator or an isotope.
